(19) United States
(12) Patent Application Publication
(10) Pub. No.: US 2003/0141818 A1
(43) Pub. Date: Jul. 31, 2003

(54) Metal halide lamp with enhanced red emission

(76) Inventor: Timothy Lee Kelly, Boston, MA (US)

Correspondence Address: Owen J. Meegan, 65 DEARBORN STREET, Salem, MA, 01970, US

(21) Appl. No.: 10/056,457

(22) Filed: Jan. 25, 2002

(51) Int. Cl. H01J 17/20; H01J 61/18

(52) U.S. Cl. 313/638

(57) ABSTRACT

A metal halide lamp with red emission equivalent to or exceeding that of a blackbody source of equal correlated color temperature. A metal halide chemistry containing CaI₂ plus a complexing metal halide of AlI₃ or GaI₃ is used to substantially increase red emission of a metal halide lamp. The inclusion of TlI in the fill chemistry is also important in influencing Ca to preferentially emit atomic and molecular red radiation of the visible spectrum while suppressing blue radiation. Optionally, a shroud of neodymium doped glass is also used to significantly filter transmission of yellow light, thereby further improving the proportion of red emission while maintaining a sufficiently white color and good general color rendering.

### BACKGROUND OF THE INVENTION

The invention relates to a metal halide discharge lamp for the generation of visible radiation. Metal halide lamps have been found desirable for many illumination applications due to their high efficacy, good general color rendering and high luminosity. Products of a wide range of lumen output and color temperature are commercially available. However, standard commercial lamps do not render red colors well as compared to incandescent light sources, which behave very closely to ideal blackbody radiators. The lamps of the present invention can be used in applications where the red rendering feature is of importance such as the illumination of fresh produce and meats or clothing and furniture or cosmetics, beauty shops and fashion retailing or paint and art retailers as well as entertainment establishments.

As specified by the Commission Internationale de l'Éclairage (CIE) in CIE publication number 13.2, the R₉ color rendering index represents a comparison between the reflected intensities of a standardized red test sample when viewed separately with two light sources, a test source and a reference source. For test sources of CCT less that 5000K the reference source is blackbody radiation of equal correlated color temperature (CCT) and illuminance. The more identical the two reflected intensities from the red test sample, the higher the R₉ value. A maximum value of 100 represents a light source that renders the specified red test sample identically to the reference source. An R₉ value less that 100 represents a light source that emits either less or more red emission as compared to the reference source. This convention is very difficult to work with when comparing red color rendering since the R₉ values give no indication whether a test source is diminished or intensified in red emission. To indicate cases where an R₉ measurement represents a lamp enhanced in red as compared to a blackbody standard, data in the detailed description of the invention is presented as 100+x where x represents the number of points of enhancement. This is not the standard notation but has proven much easier to work with. For example, if a test lamp is 20 points more red enhanced than the equivalent blackbody source, it will be referred to as 100+20 instead of the strictly proper value of 80 that cannot be distinguished in R₉ value from a lamp 20 points diminished in red. Without this notation, cumbersome graphical methods utilizing complicated color space definitions are required.

Most commercial metal halide light sources are significantly weak in red emission with negative R₉ values being common, especially for lamps with CCT <4000K. Typically, quartz arc tubes produce lower R₉ values than equivalent ceramic arc tubes. The output spectrum of a metal halide lamp is generally determined by the distribution of metals present in the gas phase at operating temperature and pressure conditions. Typically, metal halide lamps operate in a “saturated” condition, that is during operation some of the metal halides vaporize, but there is sufficient quantity present such that excess liquid or solid metal halides are still present. The overall quantity and distribution of metals in the gas phase is generally determined by the vapor pressures of the metal halides at the coldest temperature inside the arc tube body. In general, higher metal halide vapor pressure results in increased emission of the corresponding metal element. Based on experimental observation of the output spectrum, it has been noted that with certain mixtures of metal halides, some metals are present in the gas phase at a higher proportion than expected according to the known independent vapor pressures of the corresponding metal halides. R. Lorenz (“Lighting Research & Technology”, Vol 8, number 3, 1976, pp. 136-140) has explained this phenomenon with a theory of metal halide complexing. Essentially, a metal halide of low vapor pressure can react with a metal halide of high vapor pressure and high reactivity to produce a metal halide complex of higher vapor pressure than the reactant low vapor pressure metal halide. In this way the emission of a metal halide of low vapor pressure can be significantly increased in a metal halide lamp. The complexing phenomena is important to the invention in that it provides for significantly more calcium radiation than possible with the independent vaporization of CaI₂.

### PRIOR ART

U.S. patent application Ser. No. 09/427,305 “A Metal Halide Lamp with Enhanced Red Emission, in Excess of a Blackbody”, (and owned by the same assignee as the present invention) describes a lamp of similar objective but different technology. The disclosure describes a lamp that has a shroud of neodymium-doped glass to block transmittance of yellow radiation centered near 585 nm. The lamp also requires the use of metal heat shields and a vacuum outer jacket for maximum effectiveness. These features may make the lamp undesirable from a manufacturing viewpoint and the vacuum outer jacket presents a potential safety issue requiring more design considerations than a gas filled outer jacket. The elevated seal temperatures that result from the heat shielding are also a concern for long lamp life.

U.S. Pat. No. 4,027,190 to Shintani et al. and U.S. Pat. No. 4,360,758 to Thornton, Jr. et al. describe metal halide lamps that use calcium halides complexed with halides to achieve improved R₉ and general color rendering values. U.S. Pat. No. 4,742,268 to Caruso et al. describes a metal halide lamp which utilizes SnI₂+CaI₂ complexing and an ellipsoidal shaped quartz arc tube for exceptional color rendering.

Processing steps that eliminate moisture from the hygroscopic calcium iodide are also described. U.S. Pat. No. 4,801,846 to Kramer et al., describes the addition of calcium iodide to sodium iodide+rare earth iodide chemistries for enhanced red emission. U.S. Pat. No. 5,256,940 to Wada et al., describes the use of aluminum halides for complexing Na/Tl/In/Sn/Li halide chemistries to create a lamp of improved color rendering capability. U.S. Pat. No. 5,461,281 dated Oct. 24, 1995 to Fromm et al., describes as an example the use of AlI₃ as a getter material used to react with oxygen in an arc tube to prevent the attack of electrodes by metal halides. U.S. Pat. No. 6,031,332 to Wijenberg et al., describes the addition of CaI₂ to NaI+rare earth iodide chemistry to reduce crest factor and improve life. U.S. Pat. No. 6,005,346 to Shaffner describes a metal halide lamp without NaI and mercury which produces a spectrum highly saturated in primary colors for use as projection light source. Japanese Patents JPN PAT S52-120585 1977 and JPN PAT S52-031583 1977 laid open but not claimed by Toshiba corporation mention the use of Ca, however they do not mention enhancement of Ca red emission by complexing of Ca halide with the halides of Al or Ga. The role of Tl halide in suppressing atomic Ca blue radiation is not described nor is enhancing molecular Ca monohalide red radiation.

The journal “Lighting Research & Technology” vol 8, number 3, 1976, pp. 136-140 contains an article by R. Lorenz titled “Improvement of metal halide lamps by complex formation which presents a scientific explanation of metal halide complexing and provides some experimental data demonstrating the effect with metal halide lamps of various chemistries.

### SUMMARY OF THE INVENTION

In order to produce a metal halide lamp of increased red emission, CaI₂ is added to the arc tube chemistry to provide radiation the wavelength range 610 nm-650 nm which is optimal for improved red rendering as measured by the R₉ color rendering index. Due to the low vapor pressure of CaI₂, a complexing agent of AlI₃ or GaI₃ is also added to significantly increase the amount of calcium in the gas phase and thereby increase red radiation. TlI is also included in the fill chemistry in order to suppress blue radiation and preferentially enhance red calcium atomic and molecular radiation. Optionally, a bandwidth filter centered about 585 nm can be used to reduce yellow radiation and further enhance the proportion of red emission while maintaining a sufficiently white light source.

The metal halide lamp having superior red rendering characteristics comprises an arc tube formed of a material transmissive to visible radiation made from either polycrystalline alumina, sapphire or quartz.

The arc tube contains a fill of metal halides and CaI₂ or CaBr₂ plus AlI₃, AlBr₃, GaI₃ or GaBr₃ plus TlI or TlBr. The CaI₂ or CaBr₂ or both are in a molar quantity between about 10 and 75% of the total molar quantity of the total halides and the AlI₃ or AlBr₃ or both are in a molar quantity between about 2 and 50% of the total molar quantity of the total halides. The TlI of TlBr or both are in a molar quantity between about 5 and 50% of the total molar quantity of the total halides. The fill further includes mercury plus either Ar or Xe. Halides of at least one of the elements of Dy, Ho, Tm, Na, Li, Cs may be further included.

The object of the invention is to provide a metal halide lamp with significant improvement in its ability to render red colors. This is desirable for lighting retail spaces and foods such as meat, fish and produce. The appearance of human skin is also enhanced by improved red emission. The lamp can be used alone or in combination with standard light sources to improve overall red color rendering.

Another object of the invention is to provide a metal halide lamp with superior red rendition that is identical in construction to commercially available lamps of equal power.

Yet another object of the present invention is to provide a metal halide lamp that is easily manufactured with existing standard manufacturing equipment. Still another object of the present invention is to provide a metal halide lamp with superior red rendition and acceptable efficacy as well as general color rendering index and whiteness (i.e. no particular hue) so that it can be employed in general illumination applications.

Another object of the invention is to provide a light source of highly saturated primary colors (red, green and blue) which can be used for projection lighting with less filtering requirement than conventional metal halide and high pressure mercury lamps. This allows for increased system efficacy and/or an enlarged color gamut.

### BRIEF DESCRIPTIONS OF THE DRAWINGS

FIG. 1 shows the construction of a typical ceramic metal halide lamp for general illumination purpose.

FIG. 2 shows the photopic eye sensitivity transmission curve, R₉ reflectance curve, and Nd doped glass transmission curve.

FIG. 3 shows performance effects of CaI₂+AlI₃ additions to a typical 3000K CCT ceramic metal halide chemistry.

FIG. 4 shows the red enhanced performance and spectra achieved with the use of a Nd doped filter shroud for lamps of 3000K chemistry, with and without additions of CaI₂ and AlI₃.

FIG. 5 shows the red enhanced performance and spectrum achieved with a tri-component metal halide chemistry of CaI₂, AlI₃ and TlI.

FIG. 6 shows the effect of thallium iodide dose amount on spectral distribution for a CaI₂—AlI₃—TlI fill chemistry.

### DETAILED DESCRIPTION OF THE PREFERRED EMBODIMENTS

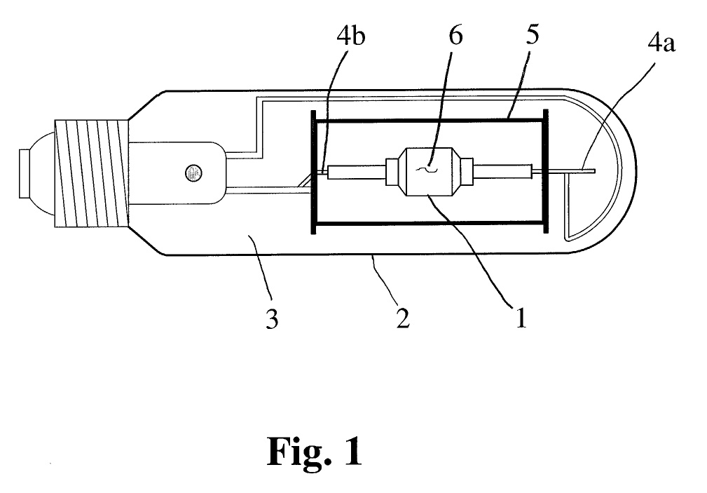

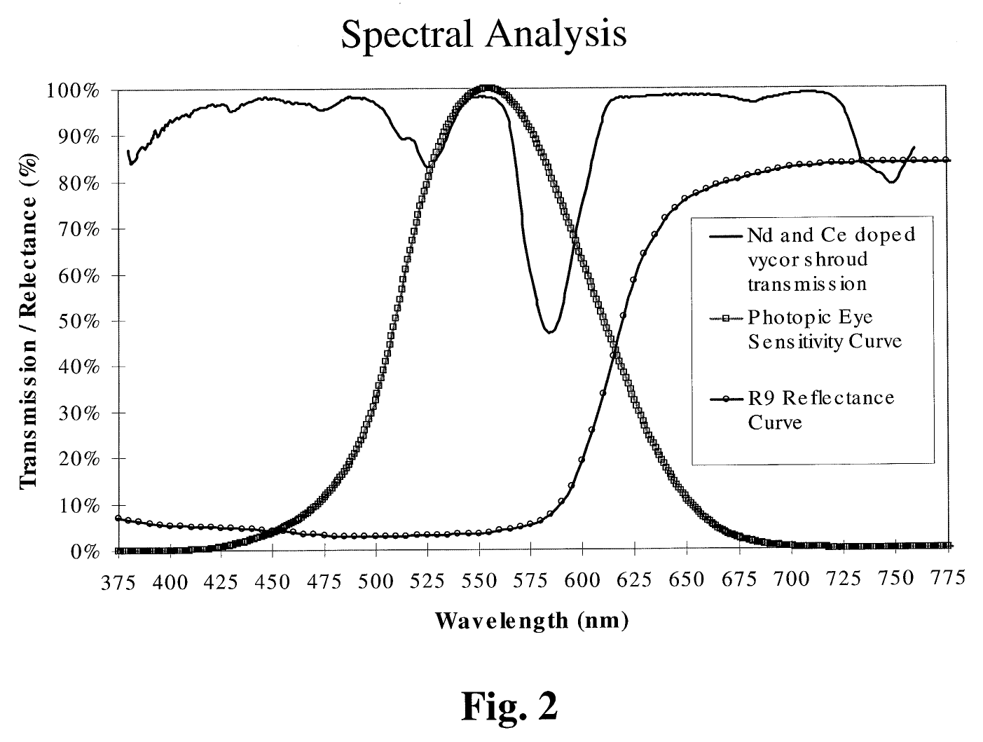

FIG. 1 shows a typical embodiment of the invention for general lighting applications. A polycrystalline alumina (PCA) arc tube 1 is housed in an outer jacket 2 of hard glass. The volume inside the jacket 3 may be evacuated or filled with nitrogen. Lamp current is conducted to and from the lamp by means of electrical feedthroughs 4a, 4b that are hermetically sealed into the arc tube 1. A tubular shroud 5 surrounding the arc tube 1 is made of hard glass or quartz and may optionally be doped with neodymium to significantly absorb visible radiation in a yellow bandwidth centered near 585 nm as shown in FIG. 2. For a lamp designed to operate at 150W, the arc tube 1 contains a fill 6 of 9-14 mg Hg, 100-300 torr Ar, and metal halides including CaI₂ for red emission and AlI₃ or GaI₃ for formation of Ca containing halide complexes. The formation of calcium-aluminum iodide complexes with vapor pressures higher than those of independent calcium iodide is important in increasing calcium in the vapor phase for more calcium red emission. Typically, TlI is included in the metal halide dose to provide green radiation for balanced color and high efficacy. TlI also serves a role in influencing calcium to emit preferentially in the red region of the spectrum.

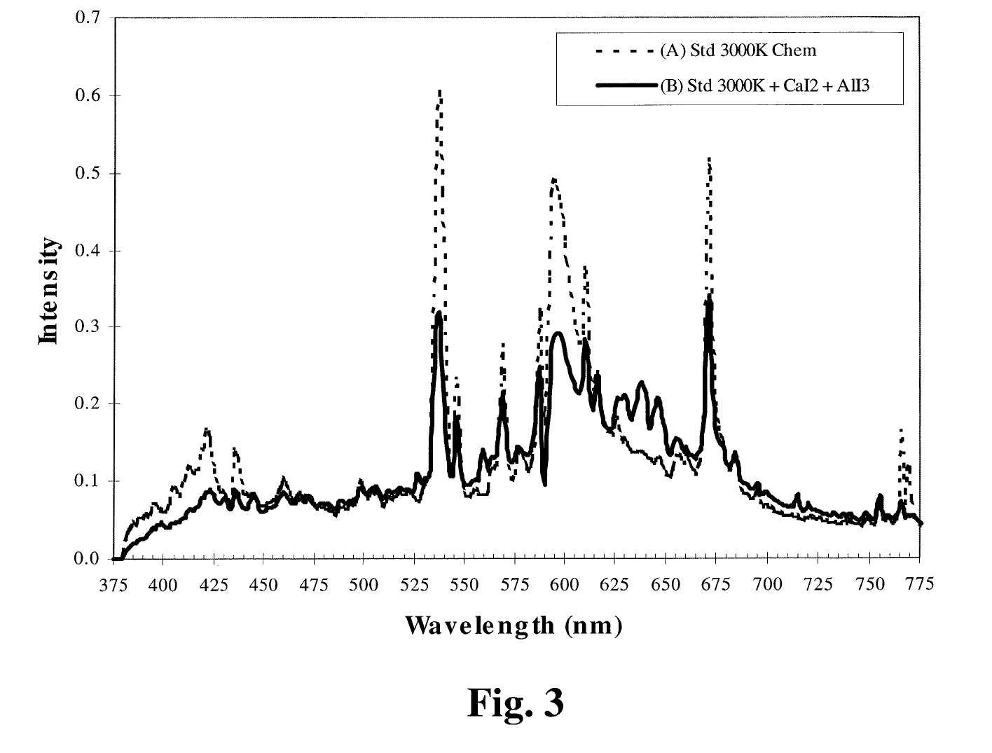

By analyzing the spectra in FIG. 2, the key advantages of the invention can be understood. The R₉ reflectance curve shows that the reflectance of spectral emission increases greatly as wavelength exceeds ˜610 nm. However, the photopic eye sensitivity curve shows that the sensitivity of the eye decreases rapidly as wavelength increases beyond 555 nm. the calcium emission seen in FIGS. 3-5 between ˜615 nm-650 nm is very effective in improving red rendering because it will reflect strongly from a red object but still be considerably visible to the human eye. Some commercial metal halide lamps include lithium halide in the fill in an attempt to improve red rendering. The predominant Li atomic emission line at 671 nm is scarcely visible to the human eye and of limited effectiveness. 611 nm Li atomic radiation is effective but typically not strong in a metal halide lamp.

In all embodiments of the invention, calcium radiation in the 615-650 region of the spectrum is the primary method of boosting red emission. There a r e several atomic calcium radiation lines tightly grouped in the 616 nm-617 nm range and also in the 644 nm-650 nm range. However, an even larger contribution of red radiation comes from calcium monoiodide molecular radiation in the 623-651 nm range.

In all embodiments of the invention either AlI₃ or GaI₃ are included in the fill chemistry with the intent of acting as both a complexing agent and as a broadband radiator of visible emission. Since Al and Ga are successive elements in the periodic table and chemically similar, both AlI₃ and GaI₃ were tested and found to be effective in combination with calcium iodide. However AlI₃ is believed to be preferable due to its higher reactivity, which makes it a more preferable complexing agent. Also, AlI₃ is believed to be more chemically compatible with a PCA arc tube and of lower cost than GaI₃.

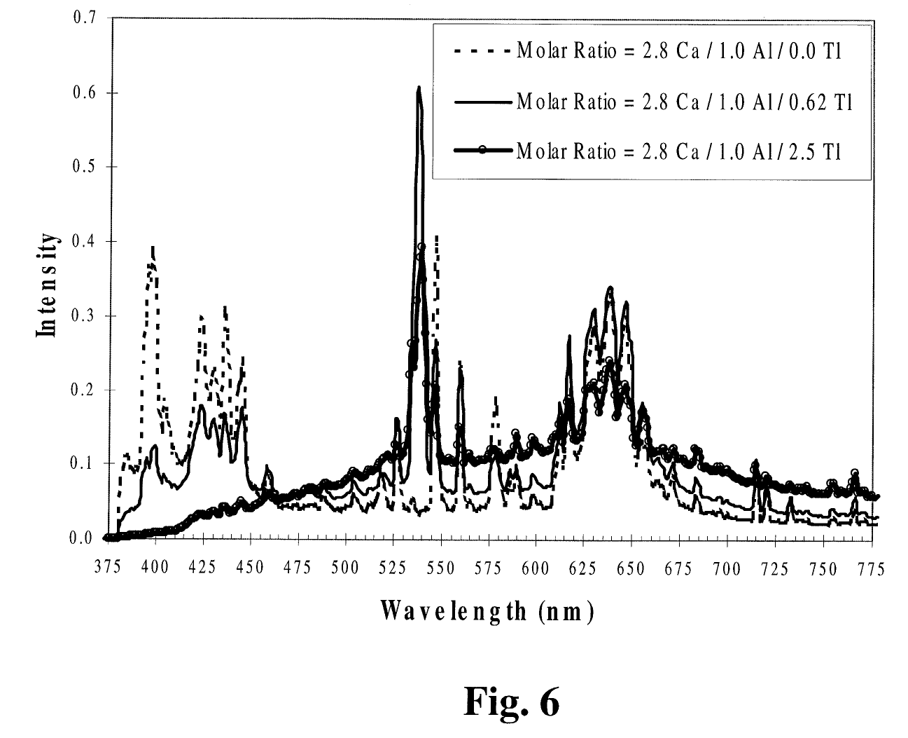

TlI serves an important role in the fill chemistry of the invention. It has been observed that increasing dosage of TlI affects R₉ performance by suppressing calcium radiation in the blue 380-450 nm range and favoring calcium emission in the 615-650 nm range. It is believed that through significant self-absorption, Tl 377.7 nm atomic radiation becomes self-reserved and creates a broad absorption notch that is increasingly widened into the visible blue wavelength with increasing TlI dose. This effect provides a very useful mechanism to limit radiation in the blue region in order to increase R₉, lower CCT, or balance spectral output to provide a white light source. The effect of TlI dose size on spectral output can be seen graphically in FIG. 6 for a CaI₂—AlI₃—TlI fill chemistry. In FIG. 6 the calcium to aluminum molar ratio is kept constant while the Tl molar ratio is adjusted. Clearly, blue radiation from 380-450 nm is suppressed as Tl dose is increased.

In some embodiments of the invention, it is desirable to increase R₉ by use of a neodymium-doped shroud 5. FIG. 2 shows the transmission spectrum of this filter used to absorb yellow radiation centered ˜585 nm. A shroud of glass doped with Nd is used to create an absorption band ˜30 nm wide at half peak intensity. This reduction of yellow radiation increases R⁹ by making the red emission proportionally larger without significantly increasing Duv. Nd doped glass is a commercially available product. Many commercial metal halide lamps commonly use a clear shroud to reduce arc tube heat loss, absorb ultraviolet radiation, and shield non-passive arc tube failures. A clear shroud can be easily substituted with a Nd doped version. Typically, the glass used is a borosilicate product of high silica content suitable for high temperature operation.

Table 1 identifies and gives performance data for some experimental embodiments of the invention as well as data from some standard commercial lamps for comparison. FIGS. 3-5 show spectral intensity graphs from some of these same lamps. All lamps except lamp E are identical in construction within normal fabrication tolerances except for the altered chemistry and Nd doped shroud in specific lamps as noted. Lamp E is of nearly identical construction but with a cylindrical shaped arc tube instead of the tapered design of lamps A-D and F-H that is shown in FIG. 1. All lamps were designed for and operated at 150W.

TABLE I

| Lamp | LPW | CRI | CCT | Duv | R9 |
|---|---|---|---|---|---|
| (A) Std 3000K | 86 | 84 | 2937 | −4.1 | −18 |
| Chemistry | | | | | |
| (B) Std 300K Chem + | 77 | 93 | 2960 | −6.3 | 53 |
| CaI₂ + AlI₃ | | | | | |
| (C) Std 3000K | 68 | 91 | 3392 | −2.2 | 74 |
| Chem + Nd doped | | | | | |
| shroud | | | | | |
| (D) Std 3000K | 65 | 88 | 3174 | −5.5 | 100 + 29 |
| Chem + CaI₂ + AlI₃ + | | | | | |
| Nd doped shroud | | | | | |
| (E) Std 4300K | 83 | 91 | 4239 | 2.2 | 40 |
| Chemistry | | | | | |
| (F) CaI₂ + AlI₃ + | 66 | 67 | 4087 | −3.7 | 100 + 130 |
| T1I Chemistry | | | | | |
| (G) CaI₂ + AlI₃ + | 72 | 84 | 3776 | −2.4 | 100 + 48 |
| T1I + DyI₃ + NaI | | | | | |
| Chemistry | | | | | |
| (H) CaI₂ + AlI₃ + | 67 | 80 | 3601 | −8.6 | 100 + 70 |
| T1I Chemistry + L:I | | | | | |

Lamp A is a standard 3000K commercial ceramic metal halide product with a metal halide chemistry of sodium iodide, thallium iodide, lithium iodide and rare earth iodides of dysprosium, holmium and thulium. Lamp B represents the first embodiment of the invention and contains doses of 6.8 μmole/cm³ CaI₂ and 2.5 μmole/cm³ AlI₃ added to the standard commercial ceramic metal halide chemistry of lamp A. In FIG. 3, the spectra of lamps A and B are plotted for comparison. For lamp B, proportionally more emission in the red (610-650 nm) region can be observed.

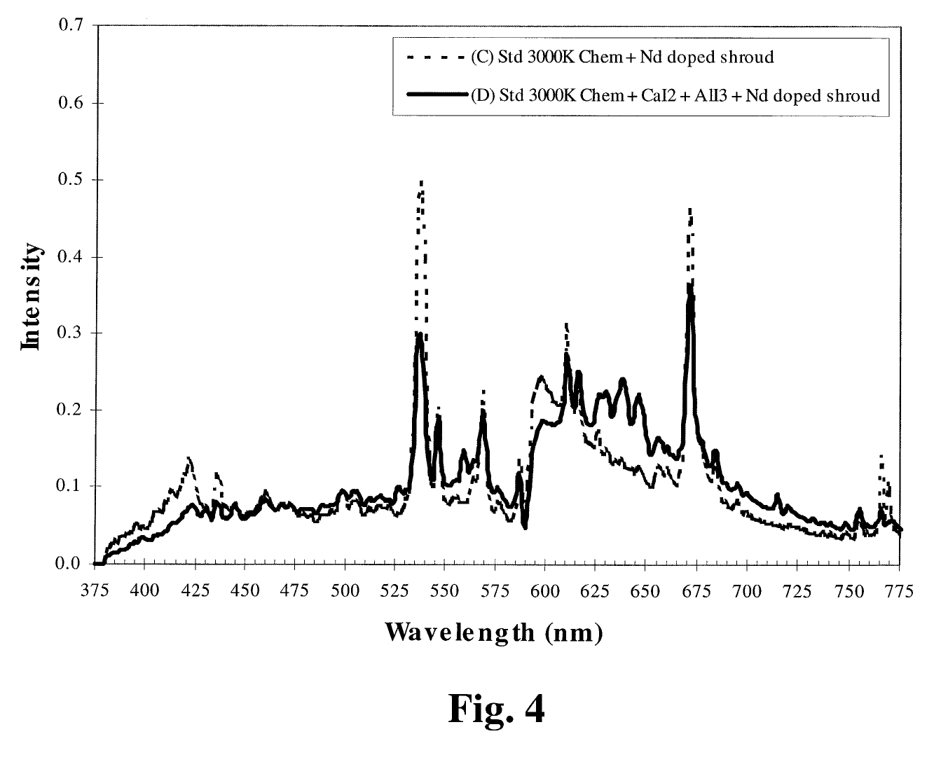

Lamps C and D are identical to lamps A and B respectively except for the tubular shroud 5 that surrounds the arc tube 1. For lamps C and D, a high silica borosilicate glass shroud appropriately doped with Nd and Ce to provide the spectral distribution curve seen in FIG. 2 is substituted for the standard clear shroud. As seen in FIG. 4, this provides an absorption notch in the spectra that increases the proportion of red emission in the spectra to increase the R₉ value without largely altering Duv or CCT. From data in Table 1, efficacy is reduced in lamps C and D by about 21% and 16% respectively when compared with lamps A and B. Lamp D represents a second embodiment of the invention. High silica borosilicate glass doped with Nd and Ce is a commercially available product. It is the Nd doping which provides for the absorption notch in the spectrum centered near 585 nm and is essential for the second embodiment of the invention. Cerium doping of shroud glass in metal halide lamps is a common practice in order to block the transmission of ultraviolet radiation. The tubular shroud used in lamps C and D is 19 mm in inner diameter with a wall thickness of 1.5 mm.

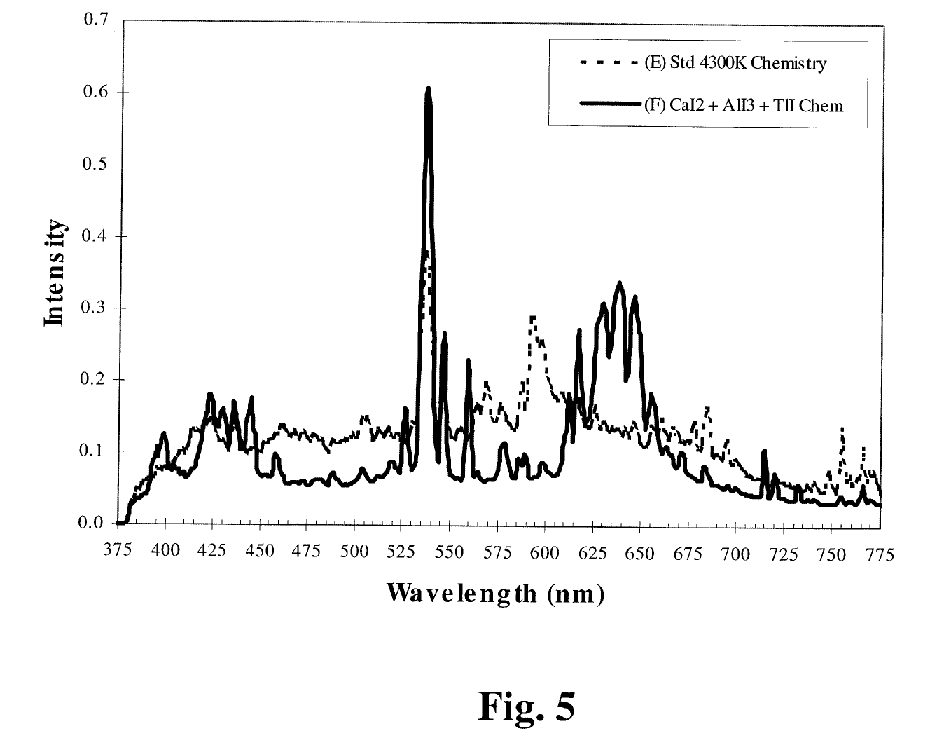

Lamp E is a standard 4300K commercial ceramic metal halide product with a metal halide chemistry of sodium iodide, thallium iodide and rare earth iodides of dysprosium, holmium and thulium. Lamp F is a third embodiment of the invention and utilizes a sodium-free tri-component metal halide chemistry of 6.8 μmole/cm³ CaI₂, 2.5 μmole/cm³ AlI₃ and 1.5. μgmole/cm³ TlI. This results in a lamp of CCT near 4000K with greatly intensified red emission as compared to an incandescent source of equal CCT. In this case, no filter is required to remove yellow radiation from the spectrum because a natural notch in the spectrum exists without sodium in the chemistry. This effect can be seen in FIG. 5 which compares the spectra of lamps E and F. In Table 1, Lamp F is measured as having an R⁹ value 100+130. This is a quite extreme value and in many lighting applications more moderately enhanced red radiation is desired. The R₉ oversaturation of a lamp F type chemistry can be reduced to a lower level for various application by adding DyI₃ or other rare earth halides, adding NaI, and adjusting the dosage of TlI.

Lamp G of Table 1, represents a fourth embodiment of the invention which has lower R₉, higher efficacy and higher CRI than Lamp F. Lamp G contains a metal halide chemistry of 6.8 μmole/cm³ CaI₃, 2.5 μmole/cm³ AlI₃, 2.4 μmole/cm³ TlI, 0.6 μmole/cm³ DyI₃, and 0.4 μmole/cm³ NaI.

Other metal halides may be added to a lamp F type chemistry for purposes such as reducing CCT. For example, LiI can be added to the chemistry of lamp F to lower CCT as shown in Lamp H of Table 1. Lamp H represents a fifth embodiment of the invention and contains a metal halide chemistry of 6.8 μmole/cm³ CaI₂, 2.5 μmole/cm³ alI₃, 1.5 μmole/cm³ LiI.

The sealing frit used to hermetically seal the electrical inlets 4a and 4b into the arc tube 1 of a ceramic metal halide lamp typically includes dysprosium oxide to resist chemical attack by the rare earth halides typically found in a commercial ceramic metal halide lamp. When using a chemical fill that does not contain rare earth halides, such as embodiment 3 (lamp F), substitution reactions may occur between dysprosium oxide and metal halides in the fill chemistry. This will result in the introduction of DyI₃ into the fill chemistry and the partial loss of original fill material. Such changes in fill chemistry are likely to alter spectral output over lamp life and result in undesirable shifts in color. To avoid such reactions, inclusion of DyI₃ in the fill chemistry is recommended. If DyI₃ is not desired in the lamp chemistry for performance reasons, an alternative sealing frit can be developed which does not contain dysprosium oxide but is chemically compatible with CaI₂, AlI₃, and TlI.

In addition to being an excellent red rendering light source for general illumination, the invention is excellent at rendering the other primary colors of green and blue as well. Embodiment 3 of the invention is especially effective in concentrating radiation in the primary red, green and blue regions of the spectrum for use in projection display devices. This can be seen in the spectrum of lamp F as shown in FIG. 5. Little radiation will be lost by the yellow, cyan and magenta notch filters typically used for projection display systems. The output spectrum of the invention can be utilized to efficiently yield a large color gamut capable of producing an exceptionally vivid color display as described by Shaffner in U.S. Pat. No. 6,005,346.

For simplicity of explanation all descriptions of the metal halide chemistries utilized in the invention have referred to as metal iodides but it is within the intent of the invention to substitute metal bromides for the described metal iodides to obtain similar results.

In my invention I claim:

1. A metal halide lamp having superior red rendering characteristics, said lamp comprising:
an arc tube formed of a material transmissive to visible radiation; and
a fill of metal halides in said vessel, said fill comprising at least one member selected from the group consisting of CaI₂, CaBr₂ plus at least one member selected from the group consisting of AlI₃₁ AlBr₃, GaI₃, GaBr₃ plus at least one member selected from the group consisting of TlI and TlBr; and
discharge electrodes disposed at opposite ends within said arc tube.

2. The lamp as claimed in claim 1 wherein the fill further comprises mercury and either Ar or Xe; and
wherein the CaI₂ or CaBr₂ or both are in a molar quantity between about 10 and 75% of the total molar quantity of the total halides; and
wherein the AlI₃ or AlBr₃ or both are in a molar quantity between about 2 and 50% of the total molar quantity of the total halides; and
wherein the TlI or TlBr or both are in a molar quantity between about 5 and 50% of the total molar quantity of the total halides.

3. The lamp as claimed in claim 1 wherein said fill further comprises mercury plus either Ar or Xe plus halides of at least one of the elements of Dy, Ho, Tm, Na, Li, Cs; and
wherein the CaI₂ or CaBr₂ or both are in a molar quantity between about 10 and 75% of the total molar quantity of the total halides; and
wherein the AlI₃ or AlBr₃ or both are in a molar quantity between about 2 and 50% of the total molar quantity of the total halides; and
wherein TlI or TlBr or both are in a molar quantity between about 5 and 50% of the total molar quantity of the total halides.

4. The lamp according to claim 1 wherein the arc tube is either polycrystalline alumina, sapphire or quartz.

5. The lamp according to claim 1 wherein the arc tube is surrounded by a glass envelope.

6. The lamp according to claim 5 wherein said envelope contains a fill gas of nitrogen at a pressure between about 250 and 600 torr.

7. The lamp according to claim 1 wherein the arc tube is surrounded by a shroud.

8. The lamp according to claim 7 wherein the shroud is made of quartz or borosilicate glass.

9. The lamp according to claim 7 wherein the shroud is of cylindrical shape.

10. The lamp according to claim 7 wherein a glass shroud enclosing the arc tube is used as a narrow band filter to reduce radiation at about 585 nm with a half peak bandwidth of between about 5 and 40 nm.

11. The lamp according to claim 10 wherein said glass shroud consists of high silica boroscilicate glass doped with appropriate amounts of Nd to achieve said filtering effect.

12. An arc tube according to claim 2 wherein the fill is sodium-free.

13. A metal halide lamp having superior red rendering characteristics, said lamp comprising:
an arc tube formed of a material transmissive to visible radiation, said material being either polycrystalline alumina, sapphire or quartz; and
a fill of metal halides in said vessel, said fill comprising at least one member selected from the group consisting of CaI₂, CaBr₂ plus at least one member selected from the group consisting of AlI₃, AlBr₃, GaI₃, GaBr₃ plus at least one member selected from the group consisting of TlI and TlBr; and
said fill further comprising mercury and either Ar or Xe; and
wherein the CaI₂ or CaBr₂ or both are in a molar quantity between about 10 and 75% of the total molar quantity of the total halides; and
wherein the AlI₃ or AlBr₃ or both are in a molar quantity between about 2 and 50% of the total molar quantity of the total halides; and
wherein the TlI of TlBr or both are in a molar quantity between about 5 and 50% of the total molar quantity of the total halides; and
wherein said fill further comprises at least one of the elements of Dy, Ho, Tm, Na, Li, Cs; and
discharge electrodes disposed at opposite ends within said arc tube.
